(19) United States
(12) Patent Application Publication
(10) Pub. No.: US 2017/0064151 A1
(43) Pub. Date: Mar. 2, 2017

(54) INFORMATION PROCESSING APPARATUS, INFORMATION PROCESSING METHOD, AND RECORDING MEDIUM

(71) Applicant: Tasuku Nagai, Kanagawa (JP)

(72) Inventor: Tasuku Nagai, Kanagawa (JP)

(73) Assignee: Ricoh Company, Ltd., Tokyo (JP)

(21) Appl. No.: 15/237,030

(22) Filed: Aug. 15, 2016

(30) Foreign Application Priority Data
Aug. 27, 2015 (JP) 2015-167646
Apr. 18, 2016 (JP) 2016-082926

(51) Int. Cl. H04N 1/60; H04N 1/407

(52) U.S. Cl. CPC H04N 1/6072; H04N 1/4072; H04N 1/6097; H04N 2201/0094

(57) ABSTRACT

An information processing apparatus includes a visibility value calculator and a color converter. The visibility value calculator is configured to calculate a value for visibility indicating a degree of easiness in viewing when document image data is output, based on a color of the document image data and a color of background image data which becomes a background when the document image data is output. The color converter is configured to convert, when the visibility value is less than a predetermined visibility tolerance, the color of the document image data so that the visibility value becomes not less than the tolerance.

### CROSS-REFERENCE TO RELATED APPLICATIONS

The present application claims priority under 35 U.S.C. §119 to Japanese Patent Application No. 2015-167646, filed Aug. 27, 2015 and Japanese Patent Application No. 2016-082926, filed Apr. 18, 2016. The contents of which are incorporated herein by reference in their entirety.

### BACKGROUND OF THE INVENTION

1. Field of the Invention

The present invention relates to an information processing apparatus, an information processing method, and a recording medium.

2. Description of the Related Art

While printing is performed conventionally by printing using a color material such as an ink and a toner onto paper (recording medium) in an image processing apparatus (a copying machine and a printer, for example) as an example of an information processing apparatus, a megascopic visibility changes depending on a color of a printed material. Here, the visibility means easiness in verification with naked eyes, that is, a degree of visibility.

For example, visibility degrades in a case of printing a yellow character compared with a case of printing a black character on white paper. Moreover, visibility of a printed material sometimes degrades in printing on color paper depending on a relation between the paper color and a color of a print content.

To secure the visibility of the printed material, a technique of performing printing by changing the color of the print content is known. For example, an image processing apparatus that allows improving the visibility and the quality of the printed material whose visibility, looking, and the like are more valued than reproducibility is disclosed in Japanese Unexamined Patent Application Publication No. 2007-96391, for example. The image processing apparatus disclosed in Japanese Unexamined Patent Application Publication No. 2007-96391 determines whether or not image data weighs heavily on visibility based on hue frequency distribution of the image data and converts at least one of density, saturation, and hue of pixel data when the image data is determined to weigh heavily on visibility.

However, there is a problem that the visibility in the case where paper is colored with a predetermined color is not taken into consideration while the visibility in the case where paper color is white is taken into consideration in the conventional image processing apparatus that performs printing by changing the color of the print content to secure the visibility. Except for the image processing apparatus, the same problem in visibility arises in a case where characters are displayed on a background image in a standby screen and the like of a mobile phone which is an example of an information processing apparatus, for example.

### SUMMARY OF THE INVENTION

According to one aspect of the present invention, an information processing apparatus includes a visibility value calculator and a color converter. The visibility value calculator is configured to calculate a value for visibility indicating a degree of easiness in viewing when document image data is output, based on a color of the document image data and a color of background image data which becomes a background when the document image data is output. The color converter is configured to convert, when the visibility value is less than a predetermined visibility tolerance, the color of the document image data so that the visibility value becomes not less than the tolerance.

### BRIEF DESCRIPTION OF THE DRAWINGS

FIG. 1 illustrates an example of a hardware configuration of an image processing apparatus according to a first embodiment;

FIG. 2 illustrates an example of a functional configuration of the image processing apparatus according to the first embodiment;

FIG. 3 is a flowchart of a print processing by the image processing apparatus according to the first embodiment;

FIG. 4 is an explanatory view of the print processing by the image processing apparatus according to the first embodiment;

FIG. 5 illustrates an example of a functional configuration of an image processing apparatus according to a second embodiment;

FIG. 6 is a flowchart of a print processing by the image processing apparatus according to the second embodiment;

FIG. 7 is an explanatory view of the print processing by the image processing apparatus according to the second embodiment;

FIG. 8 illustrates an example of a functional configuration of an image processing apparatus according to a third embodiment;

FIG. 9 is a flowchart of a print processing by an image processing apparatus according to the third embodiment;

FIG. 10 is an explanatory view of a division processing by the image processing apparatus according to the third embodiment;

FIG. 11 illustrates an example of a functional configuration of an image processing apparatus according to a fourth embodiment;

FIG. 12 is a flowchart of a print processing by the image processing apparatus according to the fourth embodiment;

FIG. 13 is an explanatory view of a division processing by the image processing apparatus according to the fourth embodiment;

FIG. 14 illustrates an example of a hardware configuration of a PC according to a fifth embodiment;

FIG. 15 illustrates an example of a functional configuration of the PC according to the fifth embodiment; and

FIG. 16 is a flowchart of a display processing by the PC according to the fifth embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An object of an embodiment is to provide an information processing apparatus, an information processing method, and a recording medium capable of improving visibility when an output content is output through a change of a color of the output content by taking a relation between the color of the output content and a background color when the output content is output into consideration.

Exemplary embodiments of an information processing apparatus, an information processing method, and a program will be explained in detail below with reference to the accompanying drawings.

### First Embodiment

In a first embodiment, an example in which an information processing apparatus is applied to an image processing apparatus is described. An image processing apparatus according to the embodiment below is a device provided with image processing functions like a multifunction peripheral, a copying machine, and a printer which include at least two of a copying function, a printing function, a scanner function, and a facsimile function.

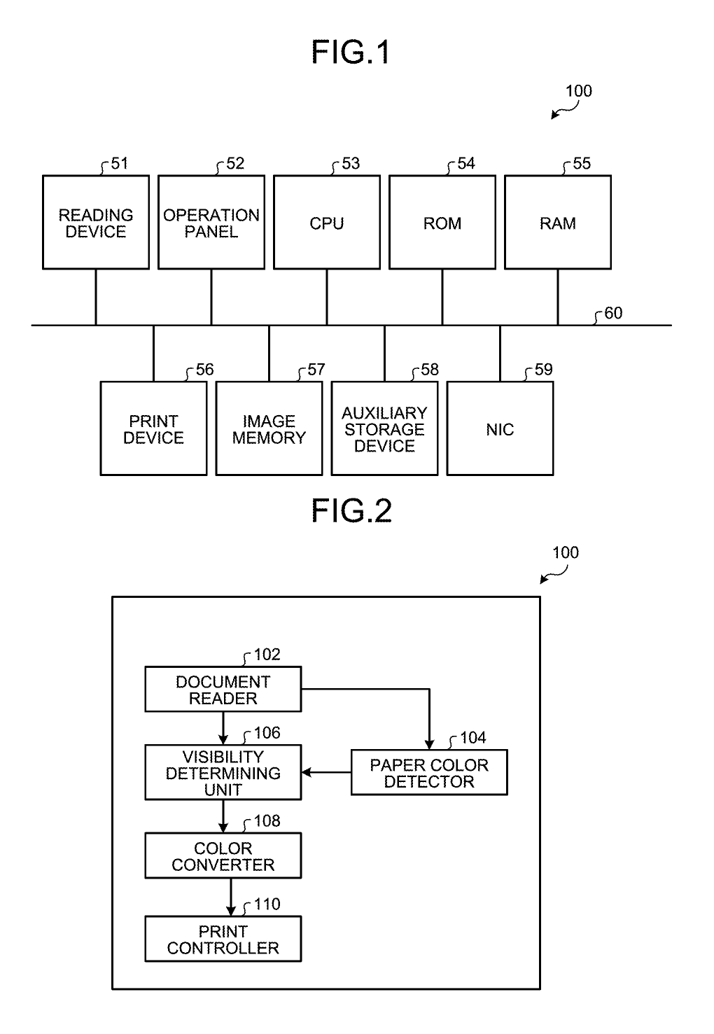

FIG. 1 illustrates an example of a hardware configuration of an image processing apparatus according to the first embodiment. An image processing apparatus 100 according to the first embodiment is provided with a reading device 51, an operation panel 52, a CPU (Central Processing Unit) 53, a ROM (Read Only Memory) 54, a RAM (Random Access Memory) 55, a print device 56, an image memory 57, an auxiliary storage device 58, and an NIC (Network Interface Card) 59. The reading device 51, the operation panel 52, the CPU 53, the ROM 54, the RAM 55, the print device 56, the image memory 57, the auxiliary storage device 58, and the NIC 59 are connected via a bus 60.

The reading device 51, which reads a document to perform a conversion into image data, is a scanner, for example. In the first embodiment, the image data read out from the document is referred to as “document image data”.

The operation panel 52, which is capable of displaying and inputting information, is a liquid crystal touch sensitive panel, for example. In the first embodiment, various kinds of settings by a user are received from the operation panel 52.

The CPU 53 executes programs to control an operation of the image processing apparatus 100. For example, the CPU 53 performs an image processing control such as a correction and scaling depending on characteristics of the reading device 51 with respect to the document image data read out by the reading device 51. The CPU 53 expands the document image data from an image processor and outputs print data required in printing. The CPU 53 also performs an image processing control such as correction depending on characteristics of the print device 56 with respect to the print data and outputs the data to the print device 56.

The ROM 54 stores programs to be executed by the CPU 53 and the like. The RAM 55 temporarily stores information regarding programs when the CPU 53 executes the programs.

The print device 56, which prints the document image data onto a recording medium such as paper, is a plotter, for example. The image memory 57 stores the document image data read out by the reading device 51 and the like. The auxiliary storage device 58, which stores information of various kinds, is a memory card, an HDD, and the like, for example. The NIC 59 communicates with other devices connected to the image processing apparatus 100.

Next, a functional configuration of the image processing apparatus 100 according to the first embodiment will be explained. FIG. 2 illustrates an example of a functional configuration of the image processing apparatus according to the first embodiment. As illustrated in FIG. 2, the image processing apparatus 100 is mainly provided with a document reader 102, a paper color detector 104, a visibility determining unit 106, a color converter 108, and a print controller 110.

The document reader 102 reads a document placed on the image processing apparatus 100 by the reading device 51 such as a scanner and generates RGB document image data used for determination on visibility. Here, the RGB document image data is image information expressed by R (red), G (green), and B (blue) colors. The visibility means easiness in verification with naked eyes, that is, a degree of visibility.

The paper color detector 104 detects a color of paper onto which the document image data generated by the document reader 102 is to be printed (output) and generates paper image data which is image data of paper. Specifically, an image sensor capable of detecting a color of paper is arranged on a conveyance pathway from a paper feeding tray in which paper is housed to a print engine to detect the color of the paper in the embodiment, for example. The paper is an example of a recording medium. The paper image data corresponds to background image data.

The method of detecting the paper color may be other methods. For example, a user input of a color of paper which is set in the paper feeding tray may be received and the paper color may be registered in the image processing apparatus 100 in advance. Before print execution by the image processing apparatus 100, paper may be read out by the reading device 51 (scanner). The paper color detector 104 corresponds to a color detector.

The visibility determining unit 106 calculates a value for visibility that indicates a degree of visibility of a printed material in the case where the document image data is printed onto paper based on a color of the document image data read out by the document reader 102 and the color of the paper image data read out by the paper color detector 104, determines visibility based on the visibility value, and notifies the color converter 108 of a result of the determination. The determination on visibility will be explained specifically here.

First of all, elements that affect visibility of a printed material as a result of printing of the document image data on a sheet of paper includes a brightness difference, a saturation difference, a hue difference between the color of the print content and the paper color. Here, the larger the brightness difference, the saturation difference, and the hue difference are, the higher the visibility of the printed material becomes.

The brightness (Y) and the saturation (S) are defined by Equations (1) and (2) below.

Brightness (Y)=(0.299*R+0.587*G+0.114*B)/255 (1)

Saturation (S)=(Iₘₐₓ−Iₘᵢₙ)/Iₘₐₓ (2)

The hue (H) differs depending on RGB and is calculated by Equation (3) below.

When “hue (H)=Undefined” and “Iₘᵢₙ=Iₘₐₓ” are true,

(60*(G−R)/(Iₘₐₓ−Iₘᵢₙ)+60)/360, where Iₘᵢₙ=B,

(60*(B−G)/(Iₘₐₓ−Iₘᵢₙ)+180)/360, where Iₘᵢₙ=R,

(60*(R−B)/(Iₘₐₓ−Iₘᵢₙ)+300)/360, where Iₘᵢₙ=G, (3)

Here, each of R, G, and B is assumed to be eight bits (0 to 255). Besides, Iₘₐₓ=MAX(R, G, B) and Iₘᵢₙ=MIN(R, G, B) are assumed to be true.

A range of a value for each of the brightness (Y), the saturation (S), and the hue (H) to be calculated is from zero to one. For example, when numerals are assigned to Equations (1) to (3) in a case of “R=255”, “G=0”, and “B=255 (magenta)”, “Y=0.41”, “S=1”, and “H=0.83” are obtained.

The brightness, the saturation, and the hue between the print content (document image data) and the paper are then defined as follows.

Yₒ: Brightness of print content, Sₒ: Saturation of print content, and Ho: Hue of print content

Yₚ: Brightness of output paper, Sₚ: Saturation of output paper, Hₚ: Hue of output content

The brightness difference between the print content and the paper color is |Yₚ−Yₒ|, the saturation difference is |Sₚ−Sₒ|, and the hue difference is |Hₚ−Hₒ|.

The document image data and the paper image data define coefficients indicating a degree of influence (degree to which an influence is given) on visibility of the printed material by respective elements of the brightness difference, the saturation difference, and the hue difference.

X_{y}: Coefficient indicating a degree of influence on visibility by brightness difference

Xₛ: Coefficient indicating a degree of influence on visibility by saturation difference

Xₕ: Coefficient indicating a degree of influence on visibility by hue difference

Here, the coefficients X_{y}, Xₛ, and Xₕ are configured to be arbitrarily set by a user so that a sum becomes one (X_{y}+Xₛ+Xₕ=1). Besides, since it is known that the degree of influence satisfies “Brightness difference>Saturation difference>Hue difference”, a combination of “X_{y}=0.6, Xₛ=0.3, and Xₕ=0.1” can be listed for example. In this manner, an arbitrary setting, regarding what element among the brightness difference, the saturation difference, and the hue difference is weighted heavily on to what extent, is allowed for visibility determination, so that a flexible determination can be made depending on a request and a preference by the user.

The visibility value (value for visibility indicating a degree of easiness in viewing the printed material) is thus defined by Equation (4) below and calculated. In this case, the larger the visibility value is, the higher the visibility becomes.

Visibility value=X_{y}*|Yₚ−Yₒ|+Xₛ*|Sₚ−Sₒ|+Xₕ*|Hₚ−Hₒ| (4)

To determine the visibility, a visibility tolerance indicating to what degree degradation in visibility value is tolerated is set by a user in advance and registered. The visibility tolerance can be set arbitrarily. In this manner, the arbitrary setting of the visibility tolerance enables a flexible setting depending on a demand and a preference by a user.

The visibility determining unit 106 calculates the visibility value based on Equations (1) to (4) above. The visibility determining unit 106 determines whether or not the calculated visibility value is less than the preset visibility tolerance and determines that “visibility is low (bad)” when the calculated visibility value is less than the visibility tolerance. The visibility determining unit 106 determines that “visibility is high (good)” when the calculated visibility value is not less than the visibility tolerance. Through a determination on visibility based on the brightness difference, the saturation difference, and the hue difference, it is possible to make an accurate determination by integrally taking an influence on the visibility due to a color difference into consideration. Here, the visibility determining unit 106 corresponds to a visibility value calculator.

When the visibility value is less than the predetermined visibility tolerance (visibility is determined to be low), the color converter 108 converts the color of the document image data so that the visibility value becomes not less than the visibility tolerance depending on a result of the determination on visibility. In other words, the color converter 108 converts the color (R, G, B) of the print content to change the Yₒ, Sₒ, and Hₒ explained above and improve the visibility of the printed material.

Specifically, the color converter 108 converts the color of the print content (document image data) to satisfy Equation (5) below.

Visibility value=X_{y}*|Yₚ−Yₒ|+Xₛ*|Sₚ−Sₒ|+Xₕ*|Hₚ−Hₒ|≦Tolerance (5)

Multiple visibility tolerances can be set and the visibility determination may be configured to range in width. The setting of multiple visibility tolerances in this manner enables obtaining improvement effect in visibility in stages. Specifically, when two visibility tolerances are allowed to be set, for example, it is possible to perform a visibility determination in three stages, i.e., “visibility is low (bad)”, “visibility is slightly low (slightly bad)”, and “visibility is high (good)” for visibility determination.

When the visibility of the printed material is determined to be good or when the visibility of the printed material is made good thorough the conversion of the color of the print content by the color converter 108, the print controller 110 prints the document image data as the print content onto a sheet of paper. On this occasion, the print controller 110 also performs a processing of converting the RGB document image data into print colors C (cyan), M (magenta), Y (yellow), and K (black).

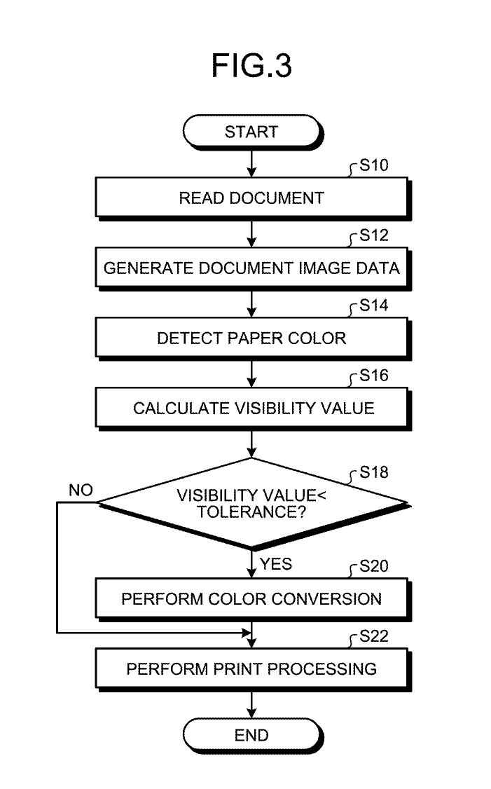

Next, a flow of a print processing by the image processing apparatus 100 according to the first embodiment will be explained. FIG. 3 is a flowchart of a print processing by the image processing apparatus according to the first embodiment.

The document reader 102 first reads a document (step S10) and generates RGB document image data from a result of the reading (step S12). When a sheet of paper onto which the document is to be printed is conveyed from the paper feeding tray toward the print engine, the paper color detector 104 uses an image sensor provided in the conveyance pathway of the paper to detect the paper color and generates paper image data (step S14).

Next, the visibility determining unit 106 calculates the visibility value of the printed material in the case where the document image data is printed onto the sheet of paper based on the document image data and the paper image data (step S16). The visibility determining unit 106 determines whether or not the visibility value of the printed material is less than the visibility tolerance (step S18), determines that the visibility is high when the visibility value of the printed material is not less than the visibility tolerance (“No” at step S18), and moves to a print processing at step S22.

On the other hand, when the visibility value of the printed material is less than the visibility tolerance (“Yes” at step S18), the visibility determining unit 106 determines that the visibility is low and moves to a color conversion processing at step S20. The color converter 108 performs a color conversion of the document image data which is the print content so that the visibility value becomes not less than the visibility tolerance depending on a result of the visibility determination (step S20).

The print controller 110 then converts the RGB document image data which is the print content, into CMYK and prints the data on the sheet of paper when the visibility of the printed material is determined to be good (step S22).

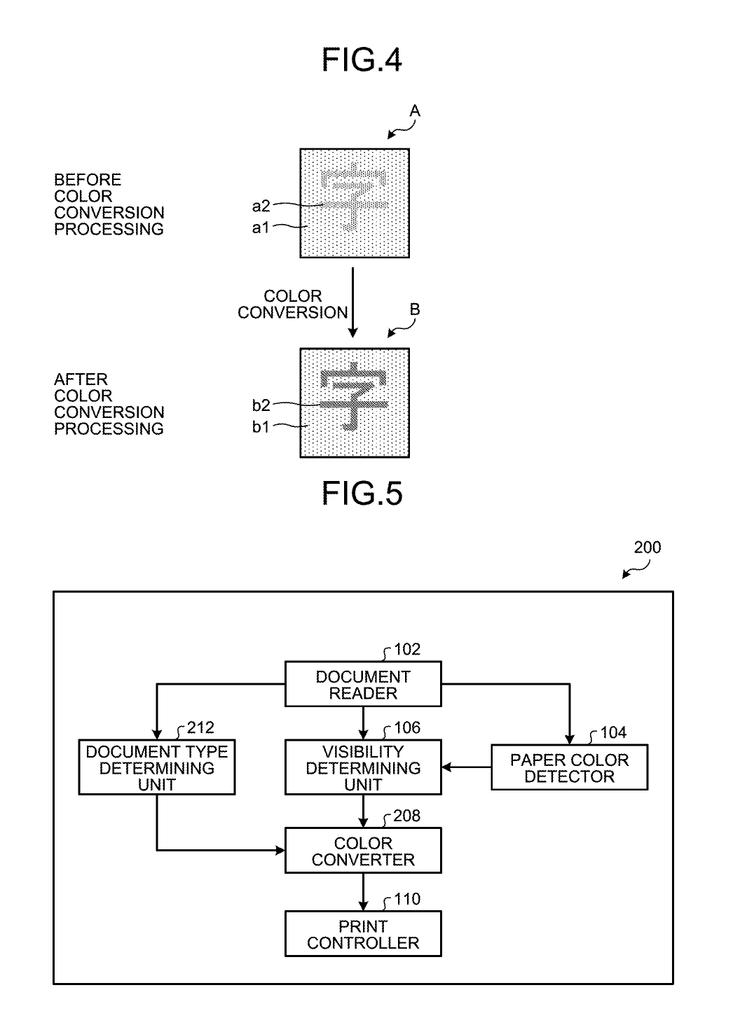

Next, the print processing by the image processing apparatus 100 according to the first embodiment will be explained by using actual numerals. FIG. 4 is an explanatory view of the print processing by the image processing apparatus according to the first embodiment. In FIG. 4, the configuration is “X_{y}=0.6, Xₛ=0.3, Xₕ=0.1, and the visibility tolerance=0.3”.

Before Color Conversion Processing

Image data A illustrated in FIG. 4 indicates document image data before the color conversion processing is performed. On this occasion, a paper color (al) is light red (R=255, G=200, B=200) and “brightness Y=0.85”, “saturation S=0.22”, and “hue H=0.00” are obtained by using Equations (1) to (3) in this case.

A character color (a2) is light magenta (R=255, G=180, B=255) and “brightness Y=0.83”, “saturation S=0.29”, and “hue H=0.83” are obtained by using Equations (1) to (3) in this case.

On this occasion, “visibility value=0.12”, which is less than the visibility tolerance, is obtained by using Equation (4), it is therefore determined that the visibility is low (bad), and the color conversion processing is performed.

After Color Conversion Processing

Image data B illustrated in FIG. 4 indicates document image data after the color conversion processing is performed. On this occasion, a paper color (b1) is light red (R=255, G=200, B=200) and “brightness Y=0.85”, “saturation S=0.22”, and “hue H=0.00” are obtained by using Equations (1) to (3) in this case.

A character color (b2) is dark magenta (R=255, G=70, B=255) and “brightness Y=0.57”, “saturation S=0.73”, and “hue H=0.83” are obtained by using Equations (1) to (3) in this case.

On this occasion, “visibility value=0.33”, which is not less than the visibility tolerance, is obtained by using Equation (4), it is therefore determined that the visibility is high (good), and the print processing is performed.

In this example, the brightness and the saturation of the character color are changed without changing the hue to change the color from the light magenta to the dark magenta, so that the visibility of the printed material is improved.

In this manner, the image processing apparatus 100 according to the first embodiment calculates the visibility value of the printed material in the case where the document image is printed onto paper based on the document image data generated by reading the document and the paper image data generated by detecting the paper color, determines the visibility based on the visibility value, and converts the color of the print content depending on the determination result. It is thus possible to convert the color of the print content by taking the relation between the color of the print content and the paper color into consideration even when the paper color is not white and to improve the visibility of the printed material.

### Second Embodiment

In a second embodiment, an example in which an information processing apparatus is applied to an image processing apparatus is described. The image processing apparatus according to the first embodiment is configured to calculate the visibility value of the printed material in the case where the document image is printed onto a sheet of paper based on the document image data and the paper image data, determine the visibility based on the visibility value, and convert the color of the print content depending on the determination result. An image processing apparatus according to the second embodiment is configured to further determine the type of document and convert the color of the print content depending on the document type.

The hardware configuration of the image processing apparatus according to the second embodiment is the same as that in the first embodiment and the explanation thereof will be omitted.

Next, a functional configuration of an image processing apparatus 200 according to the second embodiment will be explained. FIG. 5 illustrates an example of a functional configuration of the image processing apparatus according to the second embodiment. As illustrated in FIG. 5, the image processing apparatus 200 is mainly provided with the document reader 102, the paper color detector 104, the visibility determining unit 106, a document type determining unit 212, a color converter 208, and the print controller 110. Here, the document reader 102, the paper color detector 104, the visibility determining unit 106, and the print controller 110 are the same as those explained in the first embodiment and the explanation thereof will be omitted here.

The document type determining unit 212 analyzes a content of the document image data generated by the document reader 102, determines a document type with respect to a predetermined region of the document image data, and notifies the color converter 208 of a result of the determination. The document type according to the second embodiment is a picture or a character.

The color converter 208 converts the color of the document image data depending on the result of the visibility determination by the visibility determining unit 106 and the result of the document type determination by the document type determining unit 212. Specifically, when the document type is a picture, the image becomes artificial if the hue is changed through the color conversion to secure the visibility and information as a picture is diminished, which is not preferable. On the other hand, when the document type is a character, the information as a character is not diminished even if the hue is changed from the character color of the original document, which is permissible in most cases. The color conversion depending on the result of the visibility determination is the same as that in the first embodiment.

When the document type is a picture as the result of the determination by the document type determining unit 212, the color converter 208 therefore performs the color conversion of the print content within a scope of satisfying Equation (5) explained in the first embodiment and of not causing a change in hue, i.e., by changing the brightness and the saturation. It is thus possible to prevent the image from being artificial through a change in hue in the picture document and to secure the visibility.

On the other hand, when the document type is a character as the result of the determination by the document type determining unit 212, the color converter 208 performs the color conversion of the print content within the scope of satisfying Equation (5) explained in the first embodiment. In this case, the change in hue may be acceptable as far as high visibility can be obtained as a result.

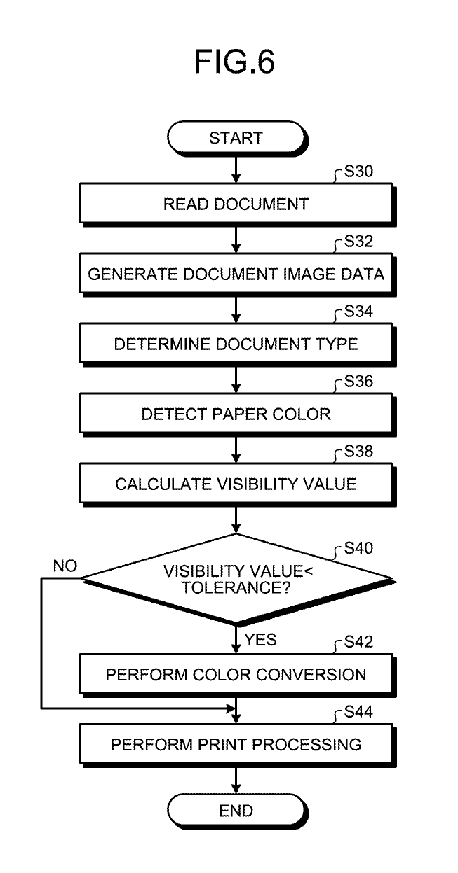

Next, a flow of a print processing by the image processing apparatus 200 according to the second embodiment will be explained. FIG. 6 is a flowchart of a print processing by the image processing apparatus according to the second embodiment.

The document reader 102 first reads a document (step S30) and generates RGB document image data from a result of the reading (step S32). The document type determining unit 212 analyzes the generated document image data to determine the type of the document (step S34). When a sheet of paper onto which the document is to be printed is conveyed from the paper feeding tray toward the print engine, the paper color detector 104 uses the image sensor provided in the conveyance pathway of the paper to detect the paper color and generates paper image data (step S36).

Next, the visibility determining unit 106 calculates the visibility value of the printed material in the case where the document image data is printed onto the sheet of paper based on the document image data and the paper image data (step S38). The visibility determining unit 106 determines whether or not the visibility value of the printed material is less than the visibility tolerance (step S40), determines that the visibility is high when the visibility value of the printed material is not less than the visibility tolerance (“No” at step S40), and moves to a print processing at step S44.

On the other hand, when the visibility value of the printed material is less than the visibility tolerance (“Yes” at step S40), the visibility determining unit 106 determines that the visibility is low and moves to the color conversion processing at step S42. The color converter 208 performs the color conversion of the document image data which is the print content so that the visibility value is not less than the visibility tolerance depending on the result of the visibility determination and the document type (step S42). On this occasion, the color conversion of the document image data is performed by changing the brightness and the saturation without changing the hue when the document type is a picture. On the other hand, the color conversion of the document image data is performed by changing the brightness, the saturation, and the hue when the document type is a character.

The print controller 110 converts the RGB document image data which is the print content into CMYK and prints the data onto the sheet of paper when the visibility of the printed material is determined to be good (step S44).

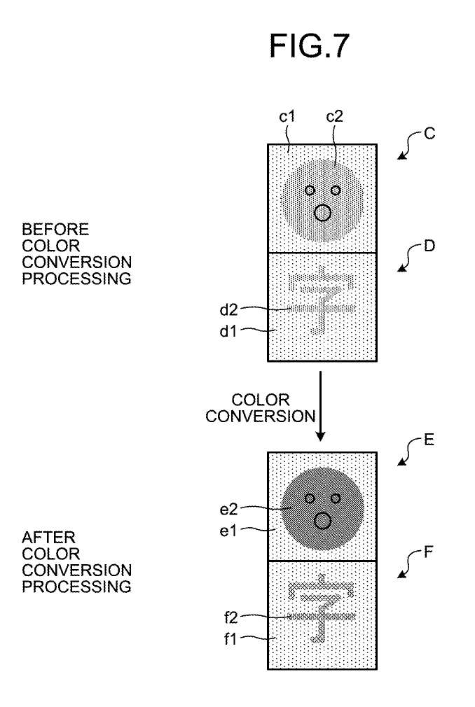

Next, the print processing by the image processing apparatus 200 according to the second embodiment will be explained by using actual numerals. FIG. 7 is an explanatory view of the print processing by the image processing apparatus according to the second embodiment. In FIG. 7, the configuration is “X_{y}=0.6, Xₛ=0.3, Xₕ=0.1, and the visibility tolerance=0.3”.

The document image data is separated by the document type determining unit 212 into a picture region and a character region. A color conversion processing different from each other is performed to each of the regions. The picture region will be explained first.

Before Color Conversion Processing

Image data C illustrated in FIG. 7 indicates a picture region of document image data before the color conversion processing is performed. On this occasion, a paper color (c1) is light red (R=255, G=200, B=200) and “brightness Y=0.85”, “saturation S=0.22”, and “hue H=0.00” are obtained by using Equations (1) to (3) in this case.

A picture color (c2) is light magenta (R=255, G=180, B=255) and “brightness Y=0.83”, “saturation S=0.29”, and “hue H=0.83” are obtained by using Equations (1) to (3) in this case.

On this occasion, “visibility value=0.12”, which is less than the visibility tolerance, is obtained by using Equation (4), it is therefore determined that the visibility is low (bad), and the color conversion processing is performed.

After Color Conversion Processing

Image data E illustrated in FIG. 4 indicates document image data after the color conversion processing is performed. On this occasion, a paper color (e1) is light red (R=255, G=200, B=200) and “brightness Y=0.85”, “saturation S=0.22”, and “hue H=0.00” are obtained by using Equations (1) to (3) in this case.

A picture color (e2) is dark magenta (R=255, G=70, B=255) and “brightness Y=0.57”, “saturation S=0.73”, and “hue H=0.83” are obtained by using Equations (1) to (3) in this case.

On this occasion, “visibility value=0.33”, which is not less than the visibility tolerance, is obtained by using Equation (4), it is therefore determined that the visibility is high (good), and the print processing is performed.

The character region will be explained next.

Before Color Conversion Processing

Image data D illustrated in FIG. 7 indicates a character region of document image data before the color conversion processing is performed. On this occasion, a paper color (d1) is light red (R=255, G=200, B=200) and “brightness Y=0.85”, “saturation S=0.22”, and “hue H=0.00” are obtained by using Equations (1) to (3) in this case.

A character color (d2) is light magenta (R=255, G=180, B=255) and “brightness Y=0.83”, “saturation S=0.29”, and “hue H=0.83” are obtained by using Equations (1) to (3) in this case.

On this occasion, “visibility value=0.12”, which is less than the visibility tolerance, is obtained by using Equation (4), it is therefore determined that the visibility is low (bad), and the color conversion processing is performed.

After Color Conversion Processing

Image data F illustrated in FIG. 7 indicates document image data after the color conversion processing is performed. On this occasion, a paper color (f1) is light red (R=255, G=200, B=200) and “brightness Y=0.85”, “saturation S=0.22”, and “hue H=0.00” are obtained by using Equations (1) to (3) in this case.

A character color (f2) is dark green (R=0, G=200, B=100) and “brightness Y=0.51”, “saturation S=1.00”, and “hue H=0.42” are obtained by using Equations (1) to (3) in this case.

On this occasion, “visibility value=0.48”, which is not less than the visibility tolerance, is obtained by using Equation (4), it is therefore determined that the visibility is high (good), and the print processing is performed.

In this example, the color is changed from the light magenta to the dark magenta by changing the brightness and the saturation without changing the hue, so that the visibility of the printed material is improved in the picture region. On this occasion, since there is no change in hue, it is possible to maintain the tint of a human face and to prevent the image from becoming artificial as a picture.

In contrast, the color is changed from the light magenta to the dark green by changing all of the brightness, the saturation, and the hue, so that the visibility of the printed material is improved in the character region. On this occasion, it is possible by tolerating the change in hue to further improve the visibility than the picture region without losing the information as character.

In this manner, the image processing apparatus 200 according to the second embodiment is configured to determine the type of the document based on the document image data generated by reading the document, calculate the visibility value of the printed material in the case where the document image is printed onto the sheet of paper based on the document image data and the paper image data generated by detecting the paper color, determine the visibility based on the visibility value, and convert the color of the print content depending on both of the determination results. It is thus possible to convert the color of the print content by taking the relation between the color of the print content and the paper color into consideration even when the paper color is not white and to improve the visibility of the printed material. Besides, it is possible since the color conversion is performed without changing hue in the case of the picture region to maintain a tint of a human face and to prevent the image from becoming artificial as a picture.

### Third Embodiment

In a third embodiment, an example in which an information processing apparatus is applied to an image processing apparatus is described. The image processing apparatus according to the first embodiment is configured to calculate the visibility value of the printed material in the case where the document image is printed onto the sheet of paper based on the document image data and the paper image data, determine the visibility based on the visibility value, and convert the color of the print content depending on the determination result.

Here, when the visibility of the document image data with respect to an entirety of the paper image data is determined in a case where there is no uniformity in the paper image data (background image data), a constituent color sometimes differs largely depending on the position of the paper image data and the visibility then varies depending on the position of a character and the like of the document image data in this case. An image processing apparatus according to the third embodiment divides the background image data as a background of the document image into a plurality of regions, determines the visibility for each of the divided regions, and changes the color of the document image data which is the print content depending on a result of the determination.

The hardware configuration of the image processing apparatus according to the third embodiment is the same as that in the first embodiment and the explanation thereof will be omitted.

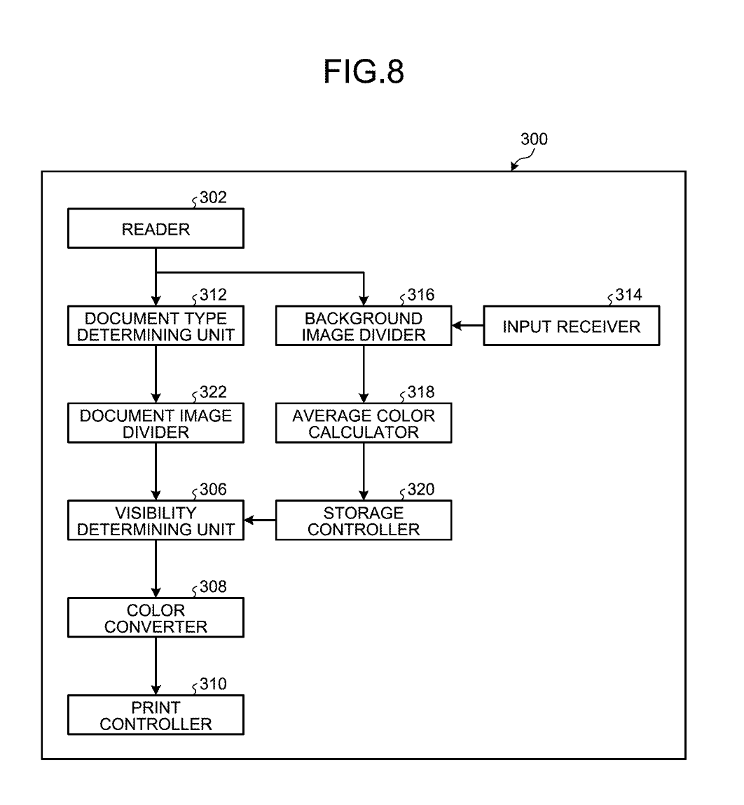

Next, a functional configuration of an image processing apparatus 300 according to the third embodiment will be explained. FIG. 8 illustrates an example of a functional configuration of the image processing apparatus according to the third embodiment. As illustrated in FIG. 8, the image processing apparatus 300 is mainly provided with a reader 302, an input receiver 314, a background image divider 316, an average color calculator 318, a storage controller 320, a document type determining unit 312, a document image divider 322, a visibility determining unit 306, a color converter 308, and a print controller 310.

The reader 302 reads a document placed on the image processing apparatus 300 by the reading device 51 and generates RGB document image data used for determination on visibility. The reader 302 also reads a sheet of paper which is placed in the image processing apparatus 300 and onto which the document image data is to be printed (output) by the reading device 51 such as a scanner and generates background image data. In this case, the background image data indicates image data of the sheet of paper (paper image data) as a background in the case where the document image data is printed. Here, the reader 302 corresponds to an acquiring unit and a reader.

In this manner, the third embodiment is configured to obtain, in the case where the sheet of paper as a background image of the document image is present, the background image data by reading the sheet of paper. However, when the background image is present as data, the background image data may be configured to be received from a PC (Personal Computer) and the like connected via a network, for example.

The input receiver 314 receives an input of a size (division size) in dividing the background image data generated by the reader 302 into a plurality of regions (background regions). Details of the division size will be explained later.

The background image divider 316 divides the background image data by the division size which is received by the input receiver 314 into a plurality of background regions. These divided background regions are sometimes referred to as “units”.

The average color calculator 318 calculates an average color for each of the units which are the background regions as the result of the division by the background image divider 316. Here, the average color is expressed by average values, for R, G, and B, of all pixels in each unit.

The storage controller 320 stores the average color, for each unit, of the background image data calculated by the average color calculator 318 in a storage unit such as the auxiliary storage device 58 and a memory. The storage controller 320 also stores the generated document image data and background image data in the storage unit such as the auxiliary storage device 58.

The document type determining unit 312 analyzes the content of the document image data generated by the reader 302 and determines the type of the document with respect to a predetermined region of the document image data. The document type according to the third embodiment is a picture or a character.

The document image divider 322 divides the document image data read out by the reader 302 into a plurality of document areas depending on the result of the determination, made by the document type determining unit 312, on the document type. The divided document areas are sometimes simply referred to as “areas”. For example, the document image divider 322 divides the document image data into areas each of which is a document area for each object depending on the document type (picture/character). Here, the object indicates a bunch of characters which make some sense, a string of characters, and a picture.

The visibility determining unit 306 calculates a value for visibility that indicates a degree of easiness in viewing a printed material when the document image data is printed onto a sheet of paper based on the color of the document image data and the color of the background image data for each of the document areas which are obtained as the result of the division of the document image data read out by the reader 302, and determines the visibility based on the visibility value. Here, the visibility determining unit 306 corresponds to a visibility value calculator.

Specifically, the visibility determining unit 306 calculates average values of an average color of at least one of the plurality of units constituting each area and treats the calculated average values as the color of the background image data of the area. In other words, when a plurality of units constituting the area are present, the visibility determining unit 306 calculates average values of average colors of the plurality of units constituting the area by adding data values, calculated by the average color calculator 318, of average colors of the units constituting the area and dividing the values by the number of units. The visibility determining unit 306 calculates the visibility value of the document image data based on the color of the background image data of the area of the calculated average values and the color of the document image data for each area to determine the visibility. The method of determining the visibility is the same as that in the first embodiment and the explanation thereof will be omitted here.

When the visibility value is less than a predetermined visibility tolerance (the visibility is determined to be low), the color converter 308 converts the color of the document image data so that the visibility value becomes not less than the visibility tolerance for each area depending on the result of the determination on visibility.

The print controller 310 prints the document image data onto the sheet of paper when the visibility value is not less than the visibility tolerance and the visibility is good (when the visibility is determined to be high) or when the visibility becomes good through color conversion of the document image data by the color converter 308. On this occasion, the print controller 310 also performs a processing of converting the RGB document image data into print colors C (cyan), M (magenta), Y (yellow), and K (black).

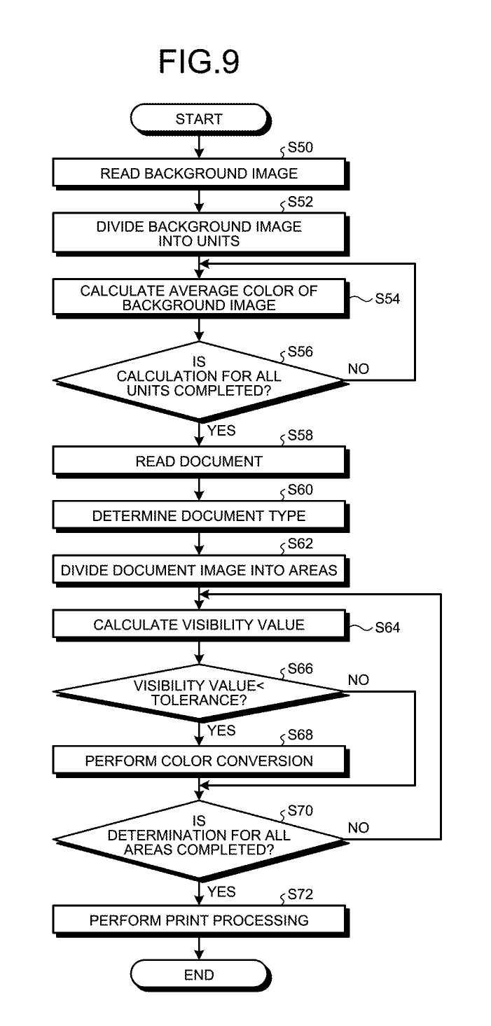

Next, a flow of a print processing by the image processing apparatus 300 according to the third embodiment will be explained. FIG. 9 is a flowchart of a print processing by the image processing apparatus according to the third embodiment.

When the sheet of paper onto which the document is to be printed is conveyed from the paper feeding tray toward the print engine, the reader 302 first reads the sheet of paper as a background of the document (step S50) and generates RGB background image data based on a result of the reading. The background image divider 316 divides the generated background image data into units by the division size received by the input receiver 314 (step S52).

Next, the average color calculator 318 calculates an average color, for each unit, of the background image data divided by the background image divider 316 (step S54). The average color calculator 318 determines whether or not the calculation of the average color for each of all the divided units is completed (step S56) and repeats the processing of calculating the average color when the calculation is not completed (“No” at step S56).

On the other hand, when the processing of calculating the average color for each of all the units is completed (“Yes” at step S56), the reader 302 reads the document (step S58) and generates RGB document image data based on the result of the reading. The document type determining unit 312 analyzes the generated document image data to determine the type of the document (step S60).

The document image divider 322 then divides the document image data read out by the reader 302 into document areas for respective objects depending on the result of the determination, made by the document type determining unit 312, on the document type (step S62).

Next, the visibility determining unit 306 calculates, for each of the divided areas, the visibility value of the printed material in the case where the document image data is printed onto the sheet of paper based on the color of the document image data and the color of the background image data (step S64). The visibility determining unit 306 determines whether or not the visibility value of the printed material is less than the visibility tolerance (step S66), determines that the visibility is high when the visibility value of the printed material is not less than the visibility tolerance (“No” at step S66), and moves to step S70.

On the other hand, when the visibility value of the printed material is less than the visibility tolerance (“Yes” at step S66), the visibility determining unit 306 determines that the visibility is low and moves to the color conversion processing at step S68. The color converter 308 performs the color conversion of the document image data which is the print content so that the visibility value is not less than the visibility tolerance for each area depending on the result of the visibility determination and the document type (step S68).

The visibility determining unit 306 determines whether or not the determination on whether or not the visibility value of the printed material is less than the visibility tolerance is completed for all the divided areas (step S70) and repeats the processing of determining the visibility when the determination is not completed (“No” at step S70).

On the other hand, when the determination on whether or not the visibility value of the printed material is less than the visibility tolerance is completed for all the divided areas (“Yes” at step S70), the print controller 310 converts the RGB document image data as the print content into CMYK to print the data onto the sheet of paper (step S72).

Here, the size of one unit (division size) by which the background image data is divided is configured to be arbitrarily set by a user in the image processing apparatus 300 according to the third embodiment as explained above.

For example, smaller size of each unit enables improving a resolution performance of the background image data and there is therefore a merit that accuracy in the visibility determination for each area is improved. In contrast, larger size of each unit enables a reduction in the number of pieces of data of the average colors to retain and there is therefore a merit that the memory can be suppressed small in size. The accuracy in the visibility determination and the memory size have a trade-off relation. Therefore, it becomes possible by allowing a user to arbitrarily set the division size to make a flexible setting depending on the accuracy in the visibility determination demanded by the user.

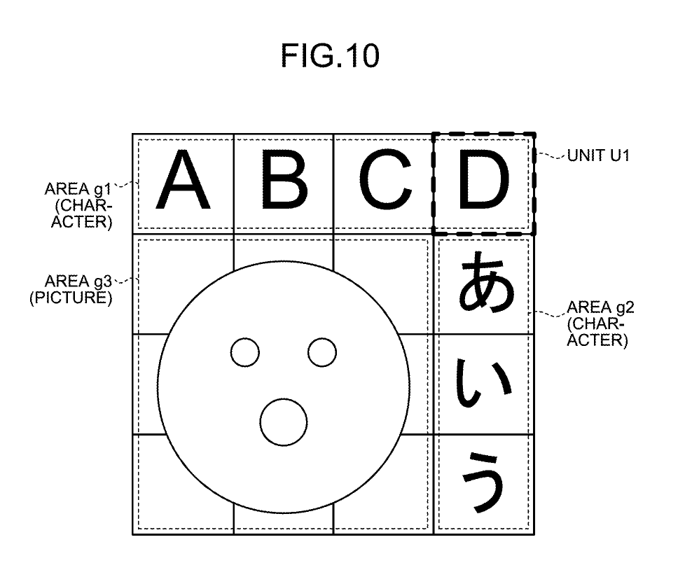

Next, a division processing of the document image data by the image processing apparatus 300 according to the third embodiment will be explained. FIG. 10 is an explanatory view of a division processing by the image processing apparatus according to the third embodiment. FIG. 10 illustrates an example of a division processing in a case where a character region and a picture region are present in the document image data.

In FIG. 10, an area g1 and an area g2 are determined to be a character region and an area g3 is determined to be a picture region by the document type determining unit 312 and the area division is made depending on respective objects. The number of units U1 constituting each of the areas g1, g2, and g3 is four, three, and nine, respectively.

The visibility determining unit 306 calculates average values of the average color of each of the units constituting each of the areas (areas g1, g2, and g3). For example, in the case of the area g1 illustrated in FIG. 10, a value obtained by dividing, by four which is the number of units, a sum of values for data of average colors of the four units (value obtained by adding values for data of average colors) is the average value of the average colors of the units constituting the area.

The visibility determining unit 306 then calculates the visibility value by using the calculated average values to determine the visibility. The color converter 308 converts the color of the document image data depending on the result of the determination on visibility and the print controller 310 prints the document image data onto the sheet of paper.

As explained so far, the image processing apparatus 300 according to the third embodiment divides the background image data generated by reading the sheet of paper onto which the document is to be printed into units and calculates the average color. The image processing apparatus 300 determines the document type based on the document image data generated by reading the document and performs the division into areas for respective objects depending on the document type. The image processing apparatus 300 then calculates average values of the average color for each area, calculates the visibility value of the printed material in the case where the document image is printed onto the sheet of paper for each area based on the color of the document image data and the color of the background image data, determines the visibility based on the visibility value, and converts the color of the document image data which is the print content depending on the determination result.

It is thus possible to convert the color of the print content by taking, into consideration, the relation between the color of the document image data which is the print content and the color of the background image data which is the sheet of paper onto which the document image data is to be printed (background image) and to improve the visibility of the printed material. Besides, it is possible by determining the visibility for each area and converting the color of the document image data as the print content to convert the color of the document image data as the print content into a color of high visibility with respect to the background image even when there is no uniformity in the background image data as the background image.

### Fourth Embodiment

In a fourth embodiment, an example in which an information processing apparatus is applied to an image processing apparatus is described. The image processing apparatus according to the third embodiment is configured to divide the background image data into a plurality of regions (units) by a division size input by a user, determine the visibility for each of areas which are obtained through the division (areas) of the document image data depending on the object, and change the color of the print content depending on the determination result. In contrast, an image processing apparatus according to the fourth embodiment divides, by a division size determined by a character size and the like of the document image, the background image data into a plurality of regions (units), determines the visibility for each of areas which are obtained by dividing the document image data depending on respective objects (areas), and changes the color of the print content depending on the determination result.

The hardware configuration of the image processing apparatus according to the fourth embodiment is the same as that in the first embodiment and the explanation thereof will be omitted.

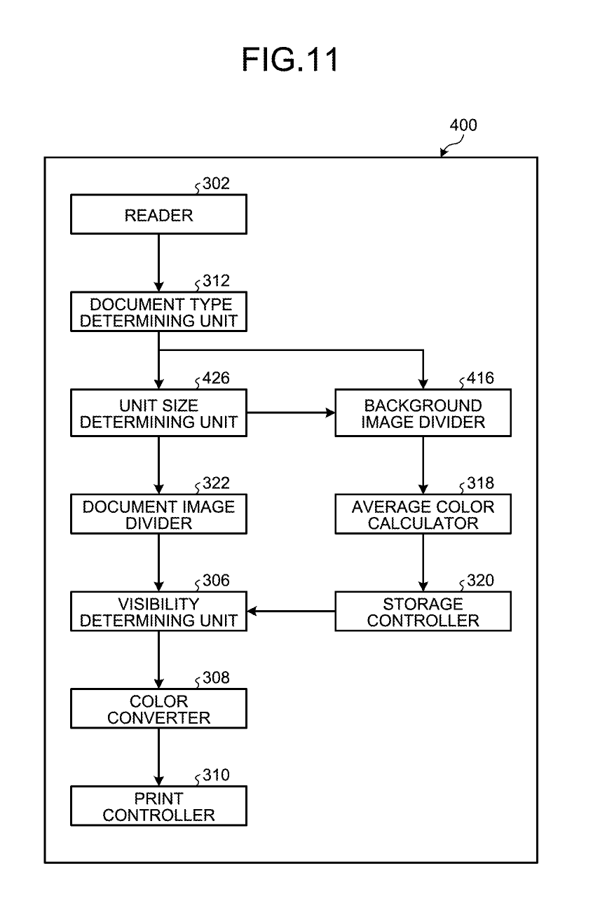

Next, a functional configuration of an image processing apparatus 400 according to the fourth embodiment will be explained. FIG. 11 illustrates an example of a functional configuration of the image processing apparatus according to the fourth embodiment. As illustrated in FIG. 11, the image processing apparatus 400 is mainly provided with the reader 302, the document type determining unit 312, a unit size determining unit 426, a background image divider 416, the average color calculator 318, the storage controller 320, the document image divider 322, the visibility determining unit 306, the color converter 308, and the print controller 310. Here, the functions and the configurations of the reader 302, the document type determining unit 312, the average color calculator 318, the storage controller 320, the document image divider 322, the visibility determining unit 306, the color converter 308, and the print controller 310 are the same as those in the third embodiment and the explanation thereof will be omitted here.

The unit size determining unit 426 analyzes the content of the document image data generated by the reader 302 and determines a size in dividing the background image data (division size) into a plurality of regions (background regions) depending on a minimum size of characters constituting the background image data. Here, the unit size determining unit 426 corresponds to a size determining unit.

Specifically, the unit size determining unit 426 performs an optical character recognition (OCR) processing with respect to an area determined to be a character region by the document type determining unit 312 and performs a separation for each character, for example. The unit size determining unit 426 then determines a unit size depending on the minimum character size among the separated characters.

The background image divider 416 divides the background image data by the division size determined by the unit size determining unit 426 into a plurality of background regions. The divided background regions are sometimes referred to as “units” similarly to the third embodiment.

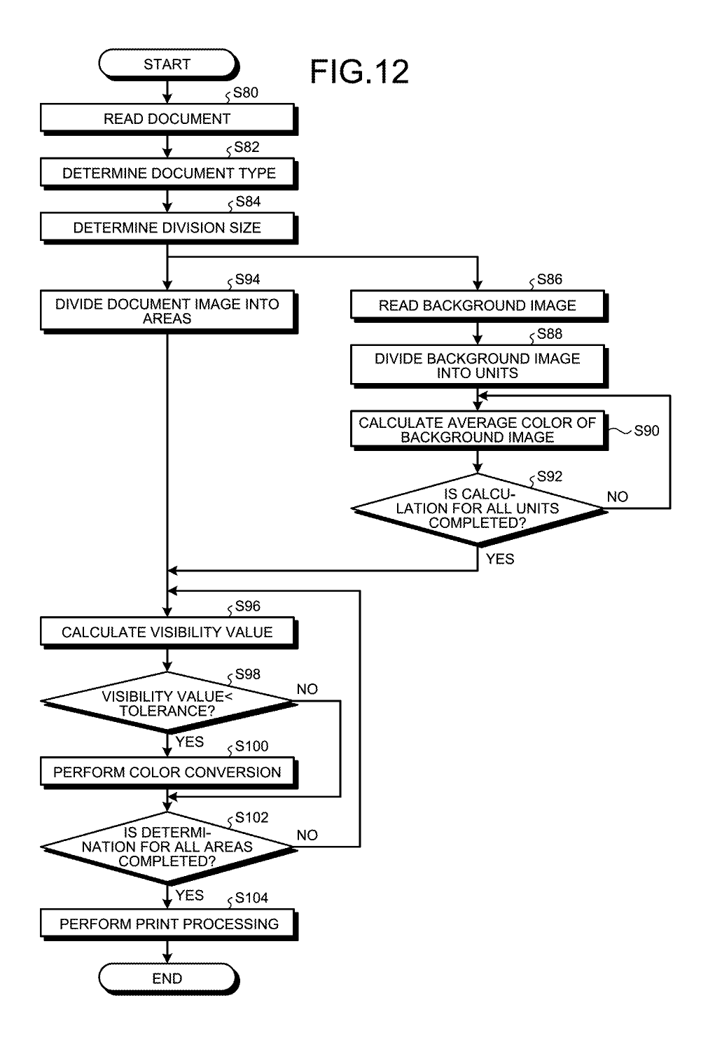

Next, a flow of a print processing by the image processing apparatus 400 according to the fourth embodiment will be explained. FIG. 12 is a flowchart of a print processing by the image processing apparatus according to the fourth embodiment.

The reader 302 first reads a document (step S80) and generates RGB document image data based on a result of the reading. The document type determining unit 312 analyzes the generated document image data to determine the type of the document (step S82). The unit size determining unit 426 then determines the division size of the background image data depending on the minimum size of the characters constituting the document image data (step S84).

The reader 302 next reads the sheet of paper as the background (step S86) and generates RGB background image data based on a result of the reading. The background image divider 416 divides the generated background image data into units by the division size determined by the unit size determining unit 426 (step S88).

Next, the average color calculator 318 calculates the average color, for each unit, of the background image data divided by the background image divider 416 (step S90). The average color calculator 318 determines whether or not the calculation of the average color for each of all the divided units is completed (step S92) and repeats the processing of calculating the average color when the calculation is not completed (“No” at step S92). On the other hand, when the calculation of the average color for each of all the units is completed (“Yes” at step S92), the processing goes to step S96.

After the division size of the background image data is determined at step S84, the document image divider 322 divides the document image data read out by the reader 302 into document areas for respective objects depending on the result of the document type determination made by the document type determining unit 312 (step S94).

The flow from the visibility calculation processing to the print processing (steps S96 to S104) is the same as that in the third embodiment and the explanation thereof will be omitted (steps S64 to S72).

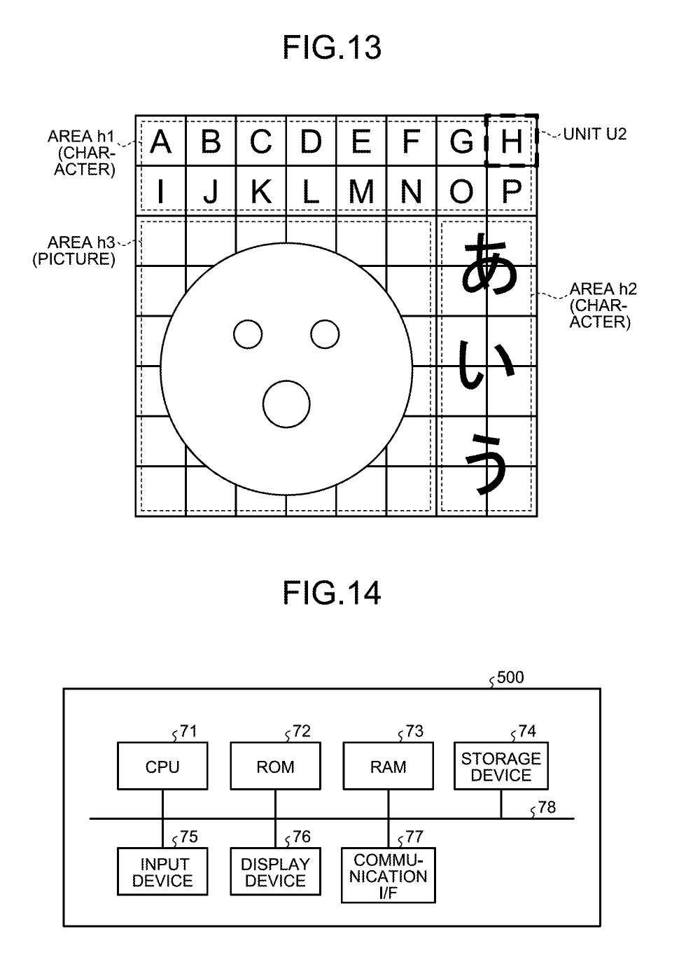

Next, a division processing of the document image data by the image processing apparatus 400 according to the fourth embodiment will be explained. FIG. 13 is an explanatory view of a division processing by the image processing apparatus according to the fourth embodiment. FIG. 13 illustrates an example of a division processing in a case where a character region and a picture region are present in the document image data.

In FIG. 13, an area h1 and an area h2 are determined to be a character region and an area h3 is determined to be a picture region by the document type determining unit 312 and the area division is made depending on respective objects. The number of units U2 constituting each of the areas h1, h2, and h3 is sixteen, twelve, and thirty six, respectively.

As illustrated in FIG. 13, the character region is the areas h1 and h2. Since the character size of the area h1 is smaller than the character size of the area h2, the characters of the area h1 have the minimum character size. The unit size determining unit 426 therefore determines the division size of a unit depending on the character size of the area h1. In other words, a square in which the character size of the area h1 fits is determined as the division size here.

In this manner, it is possible by determining the division size of the background image data depending on the minimum character size to dispense with the setting of the division size by a user. As explained, it is possible to determine a suitable division size for the trade-off relation between the accuracy in the visibility determination and the memory size and perform a print processing.

The visibility determining unit 306 calculates average values of the average color of each of the units constituting each of the areas (areas h1, h2, and h3). The visibility determining unit 306 then calculates the visibility value by using the calculated average values to determine the visibility. The color converter 308 converts the color of the document image data depending on the result of the determination on visibility and the print controller 310 prints the document image data onto the sheet of paper.

In this manner, the image processing apparatus 400 according to the fourth embodiment divides the background image data generated by reading the sheet of paper onto which the document is to be printed into units and calculates each average color. The image processing apparatus 400 determines the document type based on the document image data generated by reading the document and performs the division into areas for respective objects depending on the document type. The image processing apparatus 400 then calculates average values of the average color for each area, calculates the visibility value of the printed material for each area in the case where the document image is printed onto the sheet of paper based on the color of the document image data and the color of background image data, determines the visibility based on the visibility value, and converts the color of the document image data which is the print content depending on the determination result.

It is thus possible to convert the color of the print content by taking, into consideration, the relation between the color of the document image data which is the print content and the color of the background image data which is the sheet of paper (background image) onto which the document image data is to be printed and to improve the visibility of the printed material. Besides, it is possible by determining the visibility for each area and converting the color of the document image data as the print content to convert the color of the document image data as the print content into a color of high visibility with respect to the background image even when there is no uniformity in the background image data as the background image.

Moreover, it is possible by determining the division size of the background image data depending on the minimum character size to dispense with the setting of the division size by a user and to determine a suitable division size for the trade-off relation between the accuracy in the visibility determination and the memory size.

### Fifth Embodiment

In a fifth embodiment, an example in which an information processing apparatus is applied to a PC is described. The image processing apparatus according to the third embodiment is configured to divide the background image data obtained by reading the sheet of paper into a plurality of regions (units), determine the visibility for each of areas which are obtained through a division (areas) of the document image data depending on respective objects, change the color of the print content which is the document image data obtained by reading the document depending on the determination result, and perform printing.

For example, information such as document image data is not printed onto a sheet of paper but displayed in a display device such as a display in a digital signage and the like. There arises a problem in visibility in this case, too, similarly to the case of printing data onto a sheet of paper since document image data including characters and pictures is superimposed and displayed on the background image (background image data). To solve this problem, a technique of determining a character color of high visibility depending on the background image and changing the character color is known. For example, there is a device provided with a memory that stores background image data, calculates a brightness average value of the background image data, and changes the character color depending on a result of comparison with a reference value.

However, since one brightness average value is used for determination on visibility with respect to the entire background image in the device that makes a change into a character color of high visibility depending on the background image, there is a problem that the visibility varies depending on the position of a character when the background image is of no uniformity and the constituent color of the background image differs significantly depending on the position. So, an information processing apparatus (PC) according to a fifth embodiment divides the background image data received from an external device connected via a network into a plurality of regions, determines the visibility for each of the divided regions, and changes and displays in a display device and the like the color of an output content depending on a result of the determination.

FIG. 14 illustrates an example of a hardware configuration of a PC according to the fifth embodiment. A PC 500 according to the fifth embodiment is provided with a CPU 71, a ROM 72, a RAM 73, a storage device 74, an input device 75, a display device 76, and a communication I/F 77, which are connected mutually via a bus 78.

The CPU 71 is a computer that controls an operation of the PC 500 overall and executes programs of various kinds stored in the storage device 74. The ROM 72 is a non-volatile memory. The ROM 72 stores programs and data of various kinds necessary for an execution by the CPU 71. The RAM 73 is a main storage device such as a DRAM (Dynamic Random Access Memory) and an SRAM (Static Random Access Memory). The RAM 73 functions as a work area in which the programs of various kinds stored in the storage device 74 are expanded when executed by the CPU 71. The storage device 74, which stores the programs of various kinds to be executed by the CPU 71 and information of various kinds when the programs are executed by the CPU 71, is an HDD and the like, for example.

The input device 75 is an interface that enables a user to input various kinds of instructions with respect to the PC 500. The display device 76, which is a device that displays information of various kinds included in the PC 500, displays information such as a digital signage. The communication I/F 77 communicates with an external device via a network.

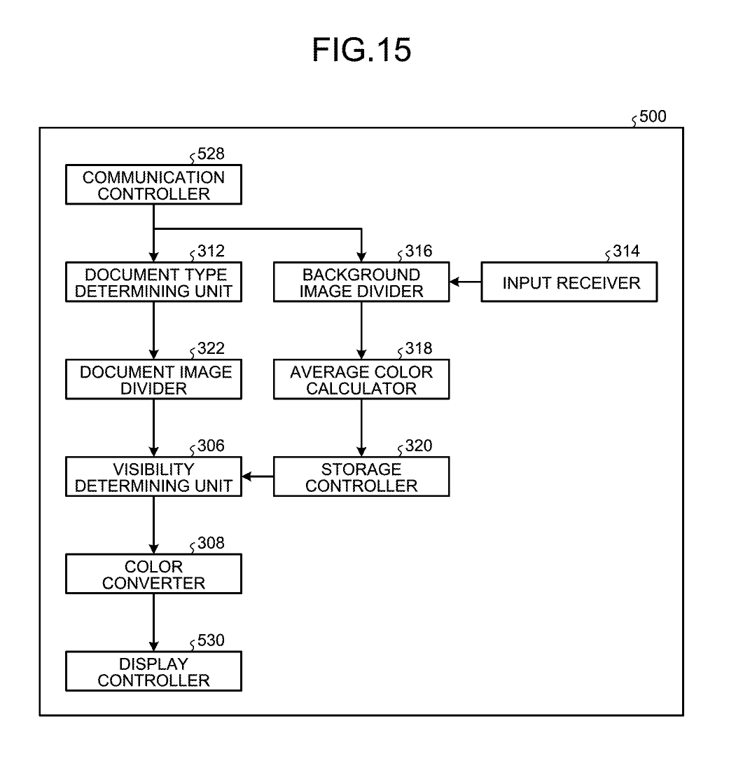

Next, a functional configuration of the PC 500 according to the fifth embodiment will be explained. FIG. 15 illustrates an example of a functional configuration of the PC according to the fifth embodiment. As illustrated in FIG. 15, the PC 500 is mainly provided with a communication controller 528, the document type determining unit 312, the input receiver 314, the background image divider 316, the average color calculator 318, the storage controller 320, the document image divider 322, the visibility determining unit 306, the color converter 308, and a display controller 530. Here, the functions and the configurations of the document type determining unit 312, the input receiver 314, the background image divider 316, the average color calculator 318, the storage controller 320, the document image divider 322, the visibility determining unit 306, and the color converter 308 are the same as those in the third embodiment and the explanation thereof will be omitted.

The communication controller 528 receives the document image data and the background image data from the external device connected via the network.

The display controller 530 arranges and displays in the display device 76 the document image data on the background image data when the visibility value is not less than the visibility tolerance and the visibility is good (when the visibility is determined to be high) or when the visibility becomes good through the color conversion of the document image data by the color converter 308.

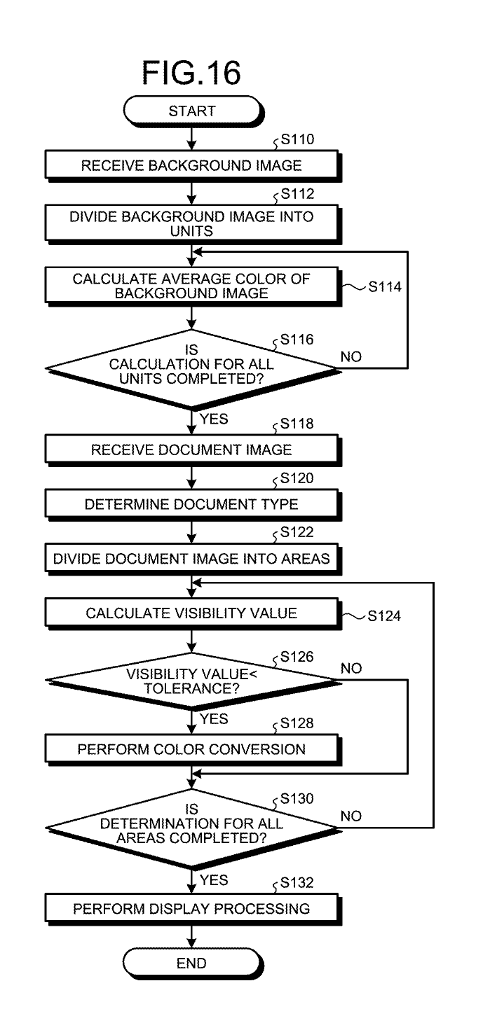

Next, a flow of a display processing by the PC 500 according to the fifth embodiment will be explained. FIG. 16 is a flowchart of a display processing by the PC according to the fifth embodiment.

First, the communication controller 528 receives the background image data as a background from the external device connected via the network (step S110). The background image divider 316 divides the received background image data into units by the division size which is received by the input receiver 314 (step S112).

Next, the average color calculator 318 calculates the average color, for each unit, of the background image data divided by the background image divider 316 (step S114). The average color calculator 318 determines whether or not the calculation of the average color for each of all the divided units is completed (step 5116) and repeats the processing of calculating the average color when the calculation is not completed (“No” at step S116).

On the other hand, when the calculation of the average color for each of all the units is completed (“Yes” at step S116), the communication controller 528 receives the document image data from the external device connected via the network (step S118). The document type determining unit 312 analyzes the received document image data to determine the type of the document (step S120). Here, the document image data may be received before the calculation of the average color of the background image data.

The document image divider 322 then divides the received document image data into document regions (areas) for respective objects depending on the result of the determination, made by the document type determining unit 312, on the document type (step S122).

Next, the visibility determining unit 306 calculates, for each of the divided areas, a visibility value of a display screen in the case where the document image data is displayed in a display and the like based on the color of the document image data and the color of the background image data (step S124). The visibility determining unit 306 determines whether or not the visibility value of the display screen is less than the visibility tolerance (step S126), determines that the visibility is high when the visibility value of the display screen is not less than the visibility tolerance (“No” at step S126), and moves to step S130.

On the other hand, when the visibility value of the display screen is less than the visibility tolerance (“Yes” at step S126), the visibility determining unit 306 determines that the visibility is low and moves to the color conversion processing at step S128. The color converter 308 performs, for each area, the color conversion of the document image data which is a display content so that the visibility value becomes not less than the visibility tolerance depending on the result of the visibility determination and the document type (step S128).

The visibility determining unit 306 determines whether or not the determination on whether or not the visibility value of the display screen is less than the visibility tolerance is completed for all the divided areas (step S130) and repeats the processing of determining the visibility when the determination is not completed (“No” at step S130).

On the other hand, when the determination on whether or not the visibility value of the display screen is less than the visibility tolerance is completed for all the divided areas (“Yes” at step S130), the display controller 530 displays the document image data as the display content in the display device 76 (step S132).

Here, while the division size by which the background image data is divided is configured to be received from a user in the fifth embodiment, the division size may be configured to be determined depending on the minimum size of the characters constituting the document image data similarly to the fourth embodiment.

As explained so far, the PC 500 according to the fifth embodiment divides the background image data received from the external device into units and calculates each average color. The PC 500 determines the document type based on the document image data received from the external device and performs the division into areas for respective objects depending on the document type. The PC 500 then calculates average values of the average color for each area, calculates, for each area, the visibility value of the display screen in the case where the document image is displayed in the display based on the color of the document image data and the color of the background image data, determines the visibility based on the visibility value, and converts the color of the document image data which is the display content depending on the determination result.

It is thus possible to convert the color of the display content by taking the relation between the color of the document image data as the display content and the color of the background image onto which the document image data is superimposed and displayed and to improve the visibility in the display screen. Besides, it is possible by determining the visibility for each area and converting the color of the document image data as the display content to convert the color of the document image data as the display content into a color of high visibility with respect to the background even when there is no uniformity in the background image data as the background image.

Programs to be executed in the image processing apparatus according to the embodiments are provided by being preloaded in a ROM and the like. The programs to be executed in the image processing apparatus according to the embodiments may be provided by being recorded in a file of an installable format or of an executable format in a computer-readable recording medium such as a CD-ROM, a flexible disk (FD), a CD-R, and a DVD (Digital Versatile Disk).

The programs to be executed in the image processing apparatus according to the embodiments may be stored on a computer connected to a network such as the Internet and provided by being downloaded via the network. The programs to be executed in the image processing apparatus according to the embodiments may be provided or distributed via a network such as the Internet.

The programs to be executed in the image processing apparatus according to the embodiments have a module configuration including the units explained above (the document reader, the visibility determining unit, the paper color detector, the color converter, and the print controller) and, as an actual hardware, the units are configured to be loaded and generated on a main storage device when the CPU (processor) reads out from the ROM and executes the programs. Besides, a part or all of the functions of the units explained above may be realized by a dedicated hardware circuit, for example.

Programs to be executed in the PC according to the embodiments are provided by being recorded in a file of an installable format or of an executable format in a computer-readable recording medium such as a CD-ROM, a flexible disk (FD), a CD-R, and a DVD (Digital Versatile Disk).

The programs to be executed in the PC according to the embodiments may be stored on a computer connected to a network such as the Internet and provided by being downloaded via the network. The programs to be executed in the PC according to the embodiments may be provided or distributed via a network such as the Internet. Besides, the programs to be executed in the PC according to the embodiments may be provided by being preloaded in a ROM and the like.

The programs to be executed in the PC according to the embodiments have a module configuration including the units explained above (the communication controller, the document type determining unit, the input receiver, the background image divider, the average color calculator, the storage controller, the document image divider, the visibility determining unit, the color converter, and the display controller) and, as an actual hardware, the units are configured to be loaded and generated on a main storage device when the CPU (processor) reads out from the ROM and executes the programs. Besides, a part or all of the functions of the units explained above may be realized by a dedicated hardware circuit, for example.

According to the embodiments, there is an advantage in that visibility when an output content is output can be improved through a change of a color of the output content by taking a relation between the color of the output content and a background color when the output content is output.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising:
a visibility value calculator configured to calculate a value for visibility indicating a degree of easiness in viewing when document image data is output, based on a color of the document image data and a color of background image data which becomes a background when the document image data is output; and
a color converter configured to convert, when the visibility value is less than a predetermined visibility tolerance, the color of the document image data so that the visibility value becomes not less than the tolerance.

2. The information processing apparatus according to claim 1, further comprising:
a document reader configured to read a document to generate the document image data; and
a color detector configured to detect a color of a recording medium to which the document image data is output to generate the background image data.

3. The information processing apparatus according to claim 1, further comprising:
a document type determiner configured to analyze a content of the document image data to determine a document type indicating one of a picture and a character with respect to a predetermined area of the document image data, wherein
the color converter changes the color of the document image data depending on a result of the determination on the document type.

4. The information processing apparatus according to claim 3, wherein the color converter changes the color of the document image data by changing brightness and saturation without changing hue when the document type is the picture.

5. The information processing apparatus according to claim 1, further comprising:
an acquirer configured to acquire the document image data and the background image data;
a document image divider configured to divide the document image data into a plurality of document areas depending on a document; and
a background image divider configured to divide the background image data into a plurality of background regions by a predetermined division size, wherein
the visibility value calculator calculates the visibility value based on the color of the document image data and the color of the background image data for each of the document areas, and
the color converter converts, when the visibility value is less than the tolerance, the color of the document image data so that the visibility value becomes not less than the tolerance for each of the document areas.

6. The information processing apparatus according to claim 5, further comprising a document type determiner configured to analyze a content of the document image data to determine a document type indicating one of a picture and a character with respect to a predetermined area of the document image data, wherein
the document image divider divides the document image data into the plurality of document areas depending on a result of the determination on the document type.

7. The information processing apparatus according to claim 5, further comprising an input receiver configured to receive an input of the division size, wherein
the background image divider divides the background image data into the plurality of background regions by the received division size.

8. The information processing apparatus according to claim 5, further comprising a size determiner configured to analyze a content of the document image data to determine the division size depending on a minimum size of character constituting the document image data, wherein
the background image divider divides the background image data into the plurality of background regions by the determined division size.

9. The information processing apparatus according to claim 5, further comprising an average color calculator configured to calculate an average color for each of the background regions, wherein
the visibility value calculator calculates average values of the average color of the at least one background region constituting each of the document areas, and calculates the visibility value by treating the calculated average values as the color of the background image data for the document area.

10. The information processing apparatus according to claim 5, wherein the acquirer is a reader configured to read a document, generate the document image data, read a recording medium to which the document image data is output, and generate the background image data.

11. The information processing apparatus according to claim 5, wherein the acquirer is a communication controller configured to receive the document image data and the background image data from an external device connected via a network.

12. The information processing apparatus according to claim 5, further comprising a print controller configured to print the document image data whose color has been converted.

13. The information processing apparatus according to claim 5, further comprising a display controller configured to arrange the document image data whose color has been converted on the background image data, and display the document image data on a display.

14. The information processing apparatus according to claim 1, wherein the visibility value calculator calculates the visibility value based on differences in brightness, saturation, and hue between the document image data and the background image data.

15. The information processing apparatus according to claim 14, wherein the visibility value calculator calculates the visibility value by adding the differences, between the document image data and the background image data, in the brightness, the saturation, and the hue each of which is multiplied by a predetermined coefficient indicating a degree of influence on the visibility.

16. The information processing apparatus according to claim 15, wherein the visibility value calculator calculates the visibility value by a following equation, Visibility value=X_{y}*|Yₚ−Yₒ|+Xₛ*|Sₚ−Sₒ|+Xₕ*|Hₚ−Hₒ|

where X_{y} is a coefficient indicating a degree of influence on the visibility by the brightness difference; Yₚ−Yₒ is the brightness difference; Xₛ is a coefficient indicating a degree of influence on the visibility by the saturation difference; Sₚ−Sₒ is the saturation difference; Xₕ is a coefficient indicating a degree of influence on the visibility by the hue difference; and Hₚ−Hₒ is the hue difference.

17. The information processing apparatus according to claim 14, wherein the visibility becomes higher as the differences in the brightness, the saturation, and the hue are larger.

18. An information processing method to be executed in an information processing apparatus, comprising:
calculating a value for visibility indicating a degree of easiness in viewing when document image data is output, based on a color of the document image data and a color of background image data which becomes a background when the document image data is output; and
converting, when the visibility value is less than a predetermined visibility tolerance, the color of the document image data so that the visibility value becomes not less than the tolerance.

19. A non-transitory recording medium with an executable program stored thereon, wherein the program, when executed by a computer, instructs the computer to perform:
calculating a value for visibility indicating a degree of easiness in viewing when document image data is output, based on a color of the document image data and a color of background image data which becomes a background when the document image data is output; and
converting, when the visibility value is less than a predetermined visibility tolerance, the color of the document image data so that the visibility value becomes not less than the tolerance.
